(19) United States
(12) Patent Application Publication
(10) Pub. No.: US 2023/0302454 A1
(43) Pub. Date: Sep. 28, 2023

(54) SAMPLE COLLECTION CONTAINERS, PROCESSES AND COLLECTED SAMPLES

(71) Applicant: STRECK, INC., La Vista, NE (US)

(72) Inventors: Sean Salamifar, Papillion, NE (US); Nick George, Omaha, NE (US); Brad Hunsley, Papillion, NE (US)

(21) Appl. No.: 18/020,893

(22) PCT Filed: Aug. 13, 2021
(86) PCT No.: PCT/US21/45874

§ 371 Date: Feb. 10, 2023

Related U.S. Application Data
(60) Provisional application No. 63/065,322, filed on Aug. 13, 2020.

(51) Int. Cl. B01L 3/00

(52) U.S. Cl. CPC B01L 3/5082; B01L 2200/16; B01L 2300/16

(57) ABSTRACT

The present teachings relate to a method of making a biological sample collection container, an internally coated biological sample collection container, and uses of the same, particularly for omic analysis. A reagent (or a reagent precursor) is deposited in a liquid state at least partially along at least one side wall of the container. The reagent precursor is dried to form a dried coating having a predefined pattern and topology along at least a portion of the at least one side wall. A container thus results having a coating that includes, in a dried state, a stabilizer agent, or reaction product of a stabilizer agent and an anticoagulant, and upon collection of a sample enables stabilization of any present white blood cells, cell-free nucleic acids, extracellular vesicles, circulating tumor cells, proteins, metabolites, lipids, or any combination thereof, and preserving them in sufficient quantity and quality for omic analysis.

### FIELD

The present teachings relate generally to containers for collection and storage of biological samples (e.g., samples having a liquid phase, such as blood, urine or other biological fluid), processes of making and/or using the same, as well as samples collected in the containers. More particularly, the teachings relate to dried reagent-coated containers or containers with extremely small amounts of liquid reagent (40 μl or less) for collection and storage of biological samples (e.g., samples having a liquid phase, such as blood, urine, saliva, mucus, or other biological fluid), processes of making and/or using the same (e.g., for subsequent omic screening, such as screening using a circulating nucleic acid, exosome or other omic), as well as samples stabilized and collected in the containers.

### BACKGROUND

The fields of noninvasive prenatal testing (“NIPT”) and liquid biopsy testing have been heavily dependent upon testing by remote clinical laboratories of blood samples containing minute (sometimes almost trace level) amounts of circulating nucleic acids. Samples commonly are drawn by venipuncture into a direct draw evacuated blood collection tube (generally 5-10 mL of blood) having a proprietary liquid stabilizing reagent in the tube. Upon draw, the blood mixes with the reagent and results in a stabilized sample for up to one week, two weeks or longer. Examples of commercially available products include Cell Free DNA BCT® and RNA Complete BCT™, both of which are available from Streck, Inc (available on Aug. 12, 2020 under catalogue numbers 230469, 230470, 230471, 218961, 218962, 218992, 218996, 218997, 230244, 230460, 230461, 230462, 230579, 230580, and 230581).

Examples of patent literature in the area of stabilization includes United States (“US”) Patent Application Publication No. 20100184069 A1 (“Preservation of Fetal Nucleic Acids in Maternal Plasma”); US Patent Application Publication No. 20160257995 A1 (“Stabilization of Nucleic Acids in Urine”); U.S. Pat. No. 10,144,955 (“Methods for Preservation of Cell-free Nucleic Acids”); and U.S. Patent Application No. 62/574,515 and International Application Publication No. WO 2019/079743A1 (“Compositions for Hemolysis and Coagulation Regulation and Stabilization of Extracellular Vesicles”), all of which are incorporated by reference for all purposes.

An effort to coat a sample collection container is illustrated in US published patent application No. 20100167271A1, incorporated by reference for all purposes.

Notwithstanding the above, there remains a need for improved sample collection containers and processes. The need is especially prevalent in the field of omics (a field of study in life sciences that possesses the suffix “-omics”, and includes for example, genomics, transcriptomics, proteomics, lipidomics, or metabolomics), where amounts and quality of analyzable targets are difficult to reliably collect and/or isolate. Further, there is an ongoing need for stabilized biological samples (e.g., samples with a liquid phase), where the amounts of sample targets for analysis (e.g., for omic analysis) are as abundant or more, as compared with existing products. There is also an ongoing need for prolonging shelf-life of reagents in collection containers prior to sample collection. There is also an ongoing need for a sample collection technology that would release active components of a stabilizing reagent in a controlled and predictable manner, to help reduce potential for sample integrity to be questioned.

There may also be a desire to reduce the amount of starting material (stabilizing reagent) necessary to provide satisfactory storage stability of biological samples. Further, many conventional blood collection tubes utilize liquid reagents that tend to lose solvent (water) during storage by evaporation and escape through the seals so that the concentration of active ingredients in solution changes over time thereby altering the stabilizing properties. It may thus be desirable to avoid such changes. There may also be a need for a stabilizing reagent that reacts more slowly than a liquid reagent.

### SUMMARY

Some or all of the above needs are met by the present teachings, which relate to sample collection containers, processes and collected samples. The containers, processes and collected samples, though having other application (as the teachings herein will reveal) generally share a common objective of stabilizing a biological sample (e.g., a biological sample having at least one liquid phase) in a manner for enabling storage, transport and handling of the samples over extended periods of time (e.g., for a period at least 36 hours, 48 hours, 72 hours, 96 hours, 120 hours, 144 hours or longer following sample collection) when compared with biological samples that have not been stabilized.

It has been surprisingly found that the inner wall of sample collection containers can be coated with a reagent (in the precursor and in a final coating) including a mixture of a stabilizer components and an anticoagulant. The coating (which may be a dry coating) provides satisfactory stability to biological samples that is comparable to that of Streck Cell Free DNA BCT but requires significantly lower quantities of stabilizer agent and anticoagulant (less than 50%-25-40 μl vs. 200 μl). It is also possible that the sample size may also be smaller than typically required (1 mL of sample or less (0.25 mL to 0.75 mL). Further, it has been surprisingly found that sample collection containers can be provided that do not require any liquids that might evaporate during storage. Thus, the inventive collection containers that are coated with dry coatings show enhanced shelf-life.

In one general sense, the present teachings pertain to a sample collection container sized and configured to secure an appropriate amount of a biological sample for omic analysis (e.g., analysis of such as genomics, proteomics, transcriptomics, lipidomics, and/or metabolomics), and including within the container a coating including a stabilizing reagent on an interior surface of the container. The biological sample may be blood, urine, saliva, mucus, cerebrospinal fluid, fecal matter, amniotic fluid, or other fluidic discharge from a human or animal, and/or any constituent of the above.

The coating (which may be a dried coating) may have a predefined pattern that spans two or three dimensions. For example, the predefined pattern may include a pattern possessing at least one continuous film. The continuous film may be continuous over a predefined length. The predefined pattern may include a plurality of coating particles. The predefined pattern may include a continuous film portion, a plurality of spaced continuous films, a plurality of discrete coating particles, a liquid or solid pellet, or any combination thereof.

The coating may have one or more predefined dimension (such as lengths, and/or thicknesses). The coating may include a plurality of coating particles (such as coating particles having a predefined dispersion of sizes and/or contact angles, or a combination thereof).

The coating may include a stabilizing reagent in a form that is capable of dissolving in the presence of, and upon contact with at least a portion of the liquid biological sample.

The dried coating may include a stabilizing reagent in a form that is capable of dispersing (e.g., after dissolution) within the biological sample for causing stabilization of any target (e.g., cell-free nucleic acids, extracellular vesicles, circulating tumor cells, or any combination thereof) intended for omic analysis.

By way of example, the sample collection container may include a receptacle portion including a base, and a side wall circumscribing the base. A container cover may be sealingly attached to the receptacle (e.g., by a friction fit, an interference fit, or otherwise). The container may include a septum (e.g., as part of a container cover) that can be ruptured and through which the sample can be introduced into the receptacle and resealed.

Further to the above, particularly in the case of blood samples, the present teachings enable and contemplate a step of retarding hemolysis of red blood cells present in the biological sample until after the transporting step has been completed.

The reagent of the present teachings (in the precursor and in a final coating) may include a formulation that results from mixing a stabilizer agent and an anticoagulant. Thus, in a dried state, a coating according to the present teachings may include a formulation that results from mixing a stabilizer agent and an anticoagulant, wherein the coating is formulated, and applied to be in a form that it is capable of: exhibiting a substantially constant concentration of the formulation that results from mixing the stabilizer agent and the anticoagulant or individual, and/or ingredients and/or reaction products thereof; after being subjected to ambient storage conditions over a prolonged period (e.g., a period of at least 90 days), dissolving in the presence of a liquid phase of a biological sample that is contacted with it; dispersing within a liquid phase of the biological sample substantially contemporaneously with a collection of the biological sample for causing stabilization of any present white blood cells, cell-free nucleic acids, extracellular vesicles, circulating tumor cells, proteins, metabolomes, or any combination thereof, and preserving them in sufficient quantity and quality for omic analysis. The reagent may be the result of a mixture of a stabilizer agent and an anticoagulant in a relative proportion (by weight) of 0.1:5 to about 8:1. For example, the stabilizer agent may be combined with an anticoagulant in an amount by weight that is about 0.1:1 to about 1:0.1 relative to each other. There may be at least 1 part by weight of anticoagulant for every 1, 2, 3, 4, 5, 6, 7, 8, 9 or 10 parts by weight of stabilizer agent. There may be at least 1 part by weight of stabilizer agent for up every 1, 2, 3, 4, 5, 6, 7, 8, 9 or 10 parts by weight of anticoagulant.

The stabilizer agent (e.g., component) may include diazolidinyl urea (DU), dimethylol urea, 2-bromo-2-nitropropane-1,3-diol, 5-hydroxymethoxymethyl-1-aza-3,7-dioxabicyclo (3.3.0)octane and 5-hydroxymethyl-1-aza-3,7-dioxabicyclo (3.3.0)octane and 5-hydroxypoly [methyleneoxy]methyl-1-aza-3,7-dioxabicyclo (3.3.0)octane, bicyclic oxazolidines (e.g. Nuosept 95), DMDM hydantoin, imidazolidinyl urea (IDU), sodium hydroxymethylglycinate, hexamethylenetetramine chloroallyl chloride (Quaternium-15), biocides (such as Bioban, Preventol and Grotan), a water-soluble zinc salt or any combination thereof. For example, the stabilizer agent may include DU, IDU or a combination of both. The stabilizer agent may include small molecule dialdehydes (e.g. fewer than 10, 8, 6, or 4 carbons) such as, e.g., glyoxal (ethanedial) and/or GAF (glyoxal acid-free).

The stabilizer agent may include one or more components to act as a solvent. Such solvents may include one or some combination of propylene glycol, iodopropynyl butylcarbamate, MeOH, EtOH, dimethylformamide (DMF) and dimethyl sulfoxide (DMSO).

The reagent may include as a starting material ingredient cyclodextrin or a functionalized derivative thereof. Such derivatives may include but are not limited to alpha-cyclodextrin, beta-cyclodextrin, gamma-cyclodextrin, sulfobutylated beta-cyclodextrin sodium salt, (2-hydroxypropyl)-beta-cyclodextrin, (2-hydroxypropyl)-gamma-cyclodextrin, methyl-beta-cyclodextrin, or combinations thereof.

The anticoagulant may include one or more compounds that bind with calcium ions and help prevent clotting. The anticoagulant may include ethylenediaminetetraacetic acid (EDTA) (e.g., either or both of K₃EDTA or K₂EDTA). The anticoagulant may include a citrate (e.g., sodium citrate or an acid-citrate-dextrose, such as citric acid, trisodium citrate, and dextrose). The anticoagulant may include an oxalate. The anti-coagulant may include heparin.

The reagent may optionally include as a starting material ingredient a compound that includes at least one functional group capable of reacting with an electron deficient functional group of an aldehyde. The optional compound may possess an amine functionality. The optional compound may be an amine compound that reacts with formaldehyde to form methylol and/or imine Schiff base or a cis-diol compound that reacts with formaldehyde to form a cyclic acetal). The optional compound may be selected from amino acids, alkyl amines, polyamines, primary amines, secondary amines, ammonium salts, nucleobases or any combination thereof. The optional compound may be selected from glycine, lysine, ethylene diamine, arginine, urea, adenine, guanine, cytosine, thymine, spermidine, or any combination thereof.

The teachings herein make possible numerous advantages as compared with existing technologies. An example of an advantage of the teachings includes that the concentration of the ingredients in the reagent, when coated and stored in a collection container of the teachings exhibit prolonged stability during storage under ambient conditions (e.g., at about room temperature (or even over a temperature range of about 6 to about 37° C.), atmospheric pressure and a relative humidity of about 40% to about 60%).

In brief, the present teachings relate to a method of making a biological sample collection container, comprising providing a container including a base; at least one side wall having a length and that is attached to the base, and including structure for defining an opening configured for receiving a cover and for receiving a biological sample, the at least one side wall defining a chamber having a volume within which a biological sample is received. The method further includes depositing a reagent comprising an anticoagulant and one or more stabilizing components in a liquid state at least partially along at least one side wall of the container and drying the reagent to form a dried coating of the reagent along at least a portion of the at least one side wall. The coating includes, in a dried state, a formulation that results from mixing the one or more stabilizer components and the anticoagulant. The coating is formulated, and applied to be in a form, that exhibits a substantially constant concentration of the formulation that results from mixing the stabilizer agent and the anticoagulant or individual, and/or ingredients and/or reaction products thereof, after being subjected to ambient storage conditions over a period of at least 90 days; dissolves in the presence of a liquid phase of the biological sample; and disperses within a liquid phase of biological sample substantially contemporaneously with a collection of the biological sample for causing stabilization of any present white blood cells, cell-free nucleic acids, extracellular vesicles, circulating tumor cells, proteins, metabolomes, or any combination thereof, and preserving them in sufficient quantity and quality for omic analysis.

The dried coating may have a predefined pattern and topology. The reagent may include, as a starting material ingredient, a stabilizer agent (e.g., component) selected from one or any combination of diazolidinyl urea (DU), dimethylol urea, 2-bromo-2-nitropropane-1,3-diol, 5-hydroxymethoxymethyl-1-aza-3,7-dioxabicyclo (3.3.0)octane and 5-hydroxymethyl-1-aza-3,7-dioxabicyclo (3.3.0)octane and 5-hydroxypoly [methyleneoxy]methyl-1-aza-3,7-dioxabicyclo (3.3.0)octane, bicyclic oxazolidines (e.g. Nuosept 95), DMDM hydantoin, imidazolidinyl urea (IDU), sodium hydroxymethylglycinate, hexamethylenetetramine chloroallyl chloride (Quaternium-15), biocides (such as Bioban, Preventol and Grotan), or a water-soluble zinc salt. The reagent may include as a starting material an ingredient with an amine functionality. The reagent may include cyclodextrin or a functionalized derivative thereof as a starting material ingredient. The reagent may include as a starting material ingredient one or any combination of anticoagulants selected from ethylenediaminetetraacetic acid (EDTA), a sodium citrate or an acid-citrate-dextrose, an oxalate or heparin. The reagent may include as starting material ingredients a stabilizer agent and an anticoagulant in a relative proportion (by weight) of 0.1:5 to about 8:1.

The coating may be in the form of a predetermined pattern of microparticles, a continuous thin film over a region of at least 2 cm² or a combination thereof. The step of coating may include applying a plurality of layers that differ in composition relative to each other. A layer of the anticoagulant may be applied over a layer of the one or more stabilizing components.

The teachings herein are further directed to a container comprising: a base; at least one side wall having a length and that is attached to the base, and including structure for defining an opening configured for receiving a cover and for receiving a biological sample, the at least one side wall defining a chamber having a volume within which a biological sample is received; a reagent comprising an anticoagulant and one or more stabilizing components in a liquid state located at least partially along at least one side wall of the container; and a substantially constant concentration of the reagent that results from mixing the one or more stabilizing components and the anticoagulant or individual, and/or ingredients and/or reaction products thereof, after being subjected to ambient storage conditions over a period of at least 90 days.

The reagent may dissolve in the presence of a liquid phase of the biological sample. The reagent may disperse within the biological sample substantially contemporaneously with a collection of the biological sample for causing stabilization of any present white blood cells, cell-free nucleic acids, extracellular vesicles, circulating tumor cells, proteins, metabolomes, or any combination thereof, and preserving them in sufficient quantity and quality for omic analysis. The reagent may form a dried coating including a predetermined array of discrete microparticles located along the at least one side wall, a thin film over at least one region of at least about 2 cm² of the side wall, or both.

The fill volume of the container may be 1 mL or less, or even 0.5 mL or less. The reagent may be located into the container as a dispersion. The amount of reagent located into the container may be 80 microliters or less, 60 microliters or less, 40 microliters or less, or even 20 microliters or less. The amount of biological sample located into the container may be 10 mL or less, 8 mL or less, 6 mL or less, or even 4 mL or less.

The teachings herein are also directed to a method of collecting a liquid biological sample in a collection container, comprising introducing a biological sample having a liquid phase into a spray coated collection container having a fill volume of 1 mL or less, or even 0.5 mL or less.

The method may include transporting the biological sample in the container to a site at which an omic analysis is performed. The method may include performing an omic analysis is performed. The step of performing an omic analysis may include one or any combination of steps including isolating a target, enriching a target, preparing a library, performing PCR, sequencing, or any combination thereof. The step of performing an omic analysis may be performed at least 36 hours after introducing the biological sample into the container. The step of performing an omic analysis may be performed no greater than 7 days after introducing the biological sample into the container.

Various features and advantages will be apparent upon review of the following detailed description.

### BRIEF DESCRIPTION OF DRAWINGS

FIG. 1a-1d illustrates examples of a sample collection container.

FIGS. 2a-2c illustrate examples of coated containers (shown are blood collection tubes).

FIGS. 3a and 3b are illustrative of results expected using the present teachings.

FIG. 4 illustrates the results of hemolysis testing of Example 3.

FIG. 5 illustrates quantitative results of plasma cell-free DNA level testing of Example 3.

FIG. 6 illustrates qualitative results of plasma cell-free DNA level testing of Example 3.

### DETAILED DESCRIPTION

The present teachings pertain in general to an interior reagent coated sample collection container that is sized and configured to store and stabilize an appropriate amount of a biological sample for omic analysis. The teachings herein have particular use and suitability for preserving a biological sample, particularly a sample having a liquid phase, for subsequent omic analysis. Such omic analysis may include processes and techniques for identification, quantification, and/or characterization of a constituent of the sample. Such omic analysis may be part of a genomic analysis, a proteomic analysis, a transcriptomic analysis, a metabolomic analysis or any combination thereof. More particular examples of suitable analytical techniques are described herein subsequently, and include polymerase chain reaction (“PCR”), quantitative real time PCR “qPCR”), sequencing (e.g., targeted sequencing, whole genome sequencing, methylation sequencing), or any combination thereof. Analytical techniques may include use of a nuclear magnetic resonance spectroscopy instrument, a liquid chromatography instrument, a mass spectrometry instrument. Any combination of instruments described in this paragraph, or some other omic analytical instrument may be employed. The analysis may be performed upon a biological sample collected in a container in accordance with the present teachings. The biological sample may be blood, urine, saliva, mucus, cerebrospinal fluid, fecal matter, amniotic fluid, or other fluidic discharge from a human or animal, and/or any constituent of the above.

One particularly attractive feature of the present teachings is based upon the recognition of advantages achievable by including, within a container, coated stabilizer reagent, on an interior surface of the container.

By “dried coating” as used herein, it is meant a coating that has lost moisture (e.g., from removal of liquid solvent that was present from the precursor), which was present within its body at a time of application to a container surface, to a degree that it has become generally rigidified and resistant to flow under its own weight at ambient conditions. Advantageously, as a result of becoming dried, the reagent will also resist becoming dislodged from a container surface during typical conditions faced during shipping and storage. For present purposes, a coating will be regarded as being “dried” when it has lost moisture that was present upon the application to such a degree that it contains less than about 15%, 10% or 5% by weight (of the total coating weight) of a liquid phase (after having been subjected to ambient conditions for 24 hours), as measured thermogravimetrically, such as by a loss on drying technique (see, e.g., USP Test method 731 (or 921 if the only liquid was water) (USP29—NF26 Page 292), incorporated by reference). By “ambient conditions,” as used herein it is meant at about 100 kilopascals (“kPa”), about room temperature (23° Celsius (“C”)), and about 30% to about 60% relative humidity (e.g., as measured in accordance with ASTM E337-15). As used herein, all references to standards such as ASTM, EN ISO, USP and the like preferably refer to the version that is officially valid on Jan. 1, 2021.

As used herein, the use of the term “coating particles” refers to discrete self-supporting cohesive masses of reagent coating in a dried condition (i.e., having less than 15%, 10% or 5% by weight of a liquid, e.g., water).

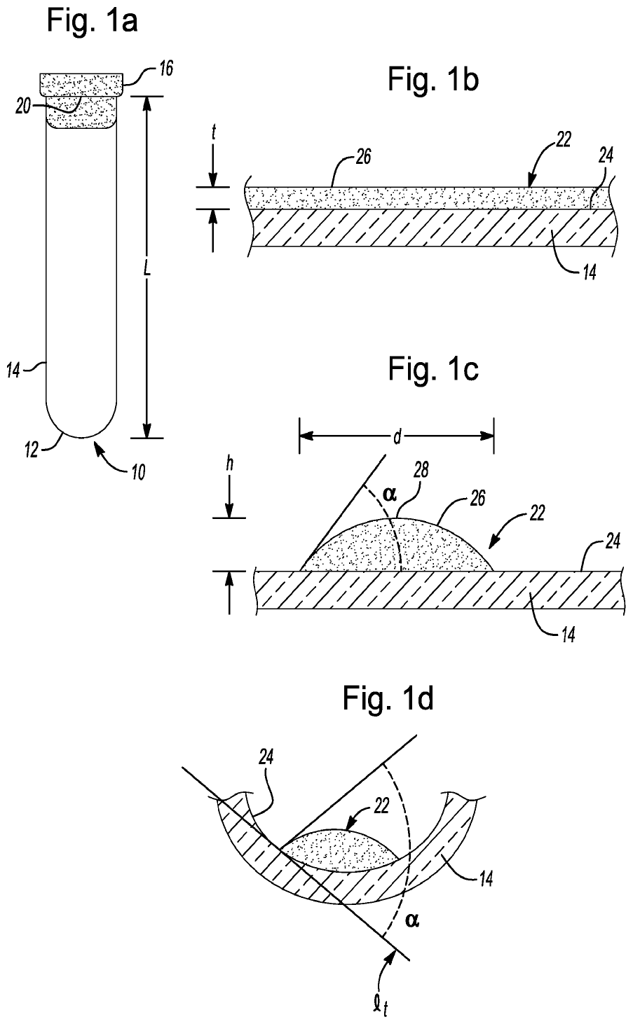

Containers in accordance with the present teachings may include a base, and a wall that circumscribes the base and defines an opening to an interior chamber of the container. A cover may be applied to close the opening. The cover may form a seal to enable a substantially evacuated condition within the chamber. By “substantially evacuated” it is meant a pressure below about 50 kPa, 40 kPa, 30 kPa, or 20 kPa. The container may have a suitable configuration for maintaining the substantially evacuated conditions for a period of at least about 6 months, 9 months, 12 months, 15 months, 18 months, 21 months, or 24 months when stored in generally ambient conditions, as defined herein. By way of example, with reference to FIG. 1a, for illustration purposes, a container 10 is shown without a coating. It has a base 12, and a side wall 14. The container has a cover 16 that sealingly closes an opening at an end region 18 opposite the base. The container has a length (L) extending from the base to an edge 20 defining the opening.

By way of example, the sample collection container may include a receptacle portion including a base, and a side wall circumscribing the base. A container cover may be sealingly attached to the receptacle portion (e.g., by a friction fit, an interference fit, or otherwise). The container may include a substantially re-sealable septum (e.g., in a container cover) that can be ruptured and through which the sample can be introduced into the chamber, but which helps prevent sample from release once within the chamber of the receptacle portion. A container may be configured as a closed end tube (e.g., as commonly employed for blood collection tubes). A container may be configured as a closed end cup. A cover may be friction fit with the container. A cover may engage with a container by way of a threading on each of cover and container. The container may rely upon gravity, a pressure differential, or both to introduce a liquid into the container. A container may be connected with a cover by a hinge. A container may be part of a self-administered blood collection device. For example, a container may be included as part of a sampling device in accordance with the teachings of Published United States patent application No. 20120010529, incorporated by reference, illustrating the use of a device that includes a push button that actuates microneedles to draw blood into a vacuum chamber serving as the container, all such components being carried on the device. The container may be part of a Tap® device provided by Seventh Sense Biosystems. For another example, a container may be included as part of a sampling device in accordance with the teachings of Published United States patent application No. 20170172481 and/or 20200085414, incorporated by reference, illustrating the use of a device that includes a spring biased actuator to advance a needle to draw blood into a collection reservoir (the container), all such components being carried on the device. The container may be part of a sample pod of a Tasso OnDemand kit. Containers may be provided as part of a sample collection kit. The container may be provided in a kit (e.g., for home and/or clinical sample acquisition), also including one or more of a hypodermic needle, swab, sanitizing wipe, culture medium, shipping package for transport of collected sample to a laboratory by a courier service, or the like.

The chamber of the receptacle portion has a predetermined volume. The volume may be at least about 0.2 ml, 1 ml, 2 ml, 3 ml, 5 ml, 7 ml, or 9 ml. The volume may be below about 200 ml, 150 ml, 120 ml, 90 ml, 60 ml or 30 ml. For example, the chamber may be sufficiently large to accommodate a blood draw volume (e.g., blood drawn via venipuncture, via microneedle drawn capillary blood or otherwise) of about 0.2 ml to about 10 ml. The chamber may be sufficiently large to accommodate a urine sample volume of about 5 ml to about 150 ml.

Containers of the present teachings may have an average wall thickness throughout at least the receptacle region configured to receive the biological sample of less than about 4 mm, 3 mm or 2.0 mm. Containers of the present teachings may have an average wall thickness throughout at least the receptacle region configured to receive the biological sample of at least about 0.5 mm or 1 mm.

The receptable portion of the containers of the present teachings may be transparent. It may be composed of a glass (e.g., borosilicate glass) or a polymer. The polymeric material may include a cyclic olefin copolymer (COC). The polymeric material may include a cyclic olefin polymer (COP). The polymeric material may include a homopolymer or copolymer that includes polyethylene, polypropylene or both. The polymeric material may include a cyclic moiety. The polymeric material may include a polyester. The polymeric material may include polyester terephthalates or polyethylene terephthalate. The polymeric material may include a polycarbonate. The polymeric material may include poly(methylmethacrylate).

The polymeric material may have certain properties or characteristics. By way of illustration, the polymeric material may have a moisture vapor transmission rate of about 0.02 g/m2/day to about 0.05 g/m2/day at 23° C. and 85% relative humidity, as measured by DIN 53 122. The polymeric material may have a tensile strength of about 60 MPa to about 63 MPa, as measured by ISO 527, parts 1 and 2. The polymeric material may have a tensile modulus of about 2300 MPa to about 2600 MPa, as measured by ISO 527, parts 1 and 2. The polymeric material may have an impact strength (Charpy Impact Unnotched) of about 20 kJ/m2 as measured by ISO 179/1 EU. The polymeric material may have a light transmission of at least about 90%. The polymeric material may have a mold shrinkage of about 0.1% to about 0.7%. The polymeric material may have a glass transition temperature of about 78° C. to about 136° C. as measured by differential scanning calorimetry (DSC).

The containers, processes and collected samples, though having other application (as the teachings herein will reveal) generally share a common objective of stabilizing a biological sample (e.g., a biological sample having at least one liquid phase) in a manner for enabling storage, transport and handling of the samples over extended periods of time (e.g., for a period at least 36 hours, 48 hours, 72 hours, 96 hours, 120 hours, 144 hours or longer following sample collection) when compared with biological samples that have not been stabilized.

The dried coating may have a predefined pattern. By “predefined pattern” it is meant a pattern that is generally consistently and reproducibly applied to each container in the course of product manufacture. To illustrate, if a production lot of at least 100 containers is treated to apply a dried coating, to the naked eye, there would be no visibly detectable differences among the at least 100 containers.

A predefined pattern may include a pattern possessing at least one continuous film having one or more predefined dimension (such as area and/or thicknesses), a plurality of coating particles (such as coating particles having a predefined dispersion of sizes and/or contact angles) or a combination thereof).

A predefined pattern may include an array of coating particles, a thin film, or a series of thin films, or any combination thereof. A predefined pattern may be applied over only a portion of an interior surface of a container.

A nozzle my be selected so that it consistently sprays a selected volume (20, 40, 60 or 80 microliters) onto the inner wall of the tube with a uniform and repeatable coating. The nozzle may be adapted to first enter the tube and then to spray the coating as the nozzle is being removed.

Depending upon the selected formulation, it may be necessary to optimize the spray process for each formulation. For example, some formulations may have a viscosity such that they require a greater nozzle power.

The application of the aqueous solutions onto plastic and glass tubes wet differently on the substrates. For the same process and volume deposition, the different surface energies of the tube materials may provide different wetting characteristics of the liquid. Smaller and more discrete droplets are seen on the plastic tubes, while larger and more accumulated drops are seen on glass. This difference may impact the coating results and/or post-processing steps.

With reference to FIG. 1b, a cross-section of a container wall 14 is shown with a thin film of dried coating particle 22 on it. The thin film has a thickness (t) from an interior surface 24 of the wall 14 to an exposed surface 26 of the coating. With reference to FIG. 1c, a cross-section of a container wall 14 is shown with a coating particle 22 on it. The coating particle has a longest dimension (“d”), shown in FIG. 1b as extending from an end one side of the particle to an end of an opposite side. The coating particle has a height (“h”) from the interior surface 24 to a peak 28. A contact angle (“α”) is shown and is described in further detail herein within this description.

The predefined pattern may be such that the coating is in adhering contact with an interior surface of the container, the container cover or both. The coating may be in adhering contact with the container, the container cover, or both over a predefined amount of the entire surface area of the interior surface of the container (e.g., entirely (100% of the container interior surface), or only partially on the interior surface. For example, the coating may be in adhering contact with the container, the container cover, or both over at least about 10%, 20%, 30%, 40%, 50%, 60%, 70%, 80% of the total interior surface. The coating may be in adhering contact with the container, the container cover, or both over less than about 95%, 85%, 75%, 65%, 55%, 45%, 35%, 25% or 15% of the total interior surface area). By “adhering contact” it is meant that at least 70%, 80% or 90% of the coating resists delamination from a surface of the container for its entire useful life after coating (e.g., for at least about 3 months, 6 months, 9 months, 12 months, 15 months, 18 months, 21 months or 24 months, prior to sample collection), when stored under ambient conditions, with or without evacuation. The teachings, accordingly contemplate a step of storing a container having a coating of a reagent and resisting delamination of the coating from a surface of the container of the present teachings for at least about 3 months, 6 months, 9 months, 12 months, 15 months, 18 months, 21 months or 24 months, prior to sample collection, and when stored under ambient conditions.

For portions of the coating that include a thin film, it is contemplated that the film defines a surface that is exposed to the sample at the outset of collection that is greater than about two square centimeters (cm²), 4 cm², 6 cm², or 8 cm². It is contemplated that the film defines a surface that is exposed to the sample at the outset of collection that is less than about 15 square centimeters (cm²), 13 cm², 11 cm², or 9 cm².

For portions of the coating that include a thin film dried coating, that thin film may have an average thickness that is less than about 1 millimeters (mm), about 0.5 mm, about 0.3 mm, or about 0.1 mm. For portions of the coating that include a thin film dried coating, that thin film may have an average thickness that is greater than about 0.001 millimeters (mm), about 0.005 mm, about 0.01 mm, or about 0.05 mm.

In addition to, or in lieu of a continuous film, the coating may be applied (to an interior wall of the container, the cover or both) for defining a predefined pattern of a plurality of coating particles. The coating particles may have an average maximum height (measured at the shortest distance from the interior wall to the highest elevation of the particle) of less than about 1 millimeters (mm), about 0.5 mm, about 0.3 mm, or about 0.1 mm. The coating particles may have an average maximum height that is greater than about 0.001 millimeters (mm), about 0.005 mm, about 0.01 mm, or about 0.05 mm.

The coating particles may have an average largest dimension (of less than about 2 millimeters (mm), about 1 mm, about 0.5 mm, about 0.3 mm, or about 0.1 mm. The coating particles may have an average largest dimension that is greater than about 0.001 millimeters (mm), about 0.005 mm, about 0.01 mm, about 0.05 mm, or about 0.1 mm. By way of example, “largest dimension,” as used herein, would be a diameter for a particle that is circular. For a rectangle having two shorter edges respectively opposing two longer edges, it would be the length of one of the longer edges.

The plurality of coating particles may include a range of different particle sizes within a region of an interior surface of the container, the cover or both.

A region for a film or plurality of coating particles may have an area greater than about 1 cm², 2 cm², 3 cm² or 4 cm² of an interior surface of the container. A region may have an area less than about 15 cm², 12 cm², 9 cm² or 6 cm² of an interior surface of the container. Regions may be defined as having a length and a width. The ratio of length to width may be from about 0.2:5 to about 5:1. For example, a region may be defined to have an area that is approximately square shaped (thus the ratio of length to width is about 1:1).

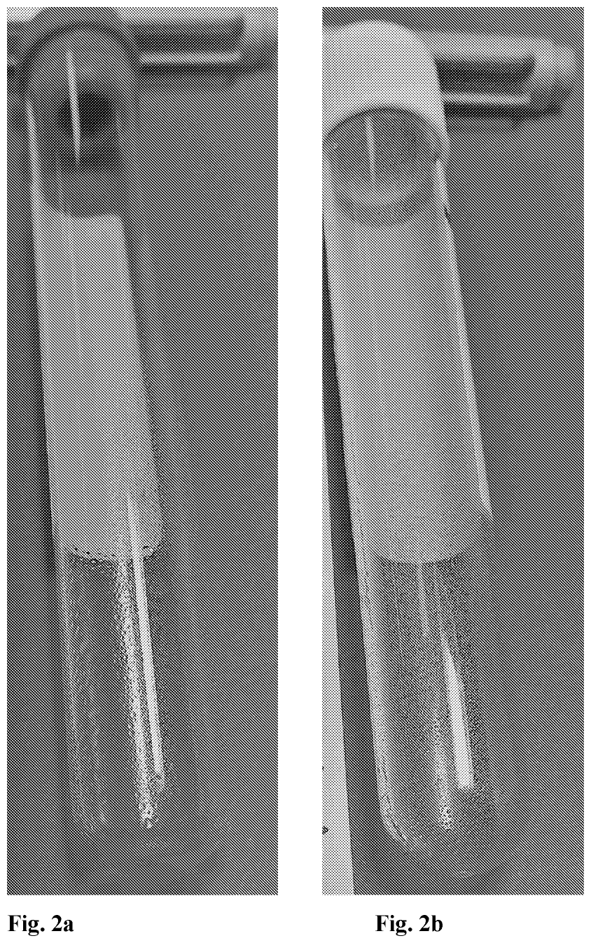

Within a region having a plurality of coating particles there may be a “dispersity” that is generally uniform, generally non-uniform, or a combination of both. For one example, a non-uniform dispersity for a given region of interest, may be such that at least about 60%, 70% or 80% of the coating particles may differ from each other in largest dimension by more than about 40%, 50% or 60%. This is seen in FIG. 2a, which shows particles of many different sizes, some being many times larger than others. For another example, a generally uniform dispersity for a given region of interest may be such that at least about 60%, 70% or 80% by weight of the coating particles may differ from each other in largest dimension by less than about 30%, 20% or 10%. This is illustrated in FIG. 2b, in which most of the particles are relatively fine and fall within a relatively narrow range of sizes.

All or some (e.g., at least 30%, 50%, or 70% by weight) of the coating particles may have a surface/coating interface area, namely an area of the particle that is in contact with a surface of the container. For all or some (e.g., at least 30%, 50%, or 70% by weight) of the coating particles, the surface/coating interface area may be at least about 0.0001 mm², 0.001 mm², 0.01 mm². For all or some (e.g., at least 30%, 50%, or 70% by weight) of the coating particles, the surface/coating interface area may be less than about 10 mm², 0.001 mm², 0.01 mm².

A predefined pattern may be defined along an inner wall of a container to extend at least partially along a length of the container. For example, a predefined pattern may extend from a base toward an opening, or vice versa, of a container. A predefined pattern may extend at least about 0.5 centimeters (“cm”), 1 cm, 3 cm, 5 cm, 7 cm or 9 cm along a length of the container. A predefined pattern may extend less than about 10 cm, 8 cm, 6 cm, 4 cm, or 3 cm along a length of the container. A predefined pattern may include an array of coating particles that radiate outwardly from one or more points on the inner wall. A predefined pattern may include an array of coating particles that radiate outwardly from a point within the container (e.g., from a center point of the container, or another point of intersection with a longitudinal axis of the container). A predefined pattern may include an array of coating particles that radiate outwardly along a line within the container (e.g., from a center line of the container, or along at least a portion of a longitudinal axis of the container). For example, in the context of coating a container, it is possible that one or more steps of coating may include locating an outlet of a dispensing nozzle at a longitudinal axis of the container, substantially at (e.g., within less than about 3 mm) a wall of the container, or against a wall of the container and causing the nozzle to eject precursor. It is possible that one or more steps of coating may include locating an outlet of a dispensing nozzle at a longitudinal axis of the container, substantially at (e.g., within less than about 3 mm) a wall of the container, or against a wall of the container and causing the nozzle to eject precursor while one or both of the container and the nozzle are translated relative to one another (e.g., linearly, rotationally or both). As can be seen, a coating can be selectively applied to one or more regions of a container for realizing a predefined pattern that may be confined to one or more relatively small regions, to one or more relatively large regions, or a combination of both. As the teachings also illustrate, the predefined pattern may include one or more regions having a single layer or having a plurality of layers. Some regions may include both single layers of coating particles and multiple layers of coating particles within a single region.

A predefined pattern may be such that the dispersity is approximately the same in adjoining regions, or different in adjoining regions.

The coating particles of the base may be the same or different in morphology, topology and/or size as compared with coating particles along a wall. By way of example, it may prove advantageous to employ multiple predefined regions of a plurality of particles, with each region having an average particle size that differs from another region by at least 50%, 75%, or 100%. For example, it is possible that a base of a container will have coated thereon a plurality of coating particles that average at least 0.7 mm, 1 mm or 1.5 mm in largest dimension, while along the walls the coating particles average about no more than about 0.4 mm in largest dimension. FIG. 2c illustrates this with an example in which a glass tube (tube on right) has coating particles on its base that are larger in average largest dimension than those along a side wall. The coating particles also exhibit a differing morphology on the base as compared side wall morphology. In contrast, FIG. 2c illustrates an example in which a polymeric tube (tube on left) has coating particles that have a similar and more consistent coating particle size on its base and along its side wall.

As used herein, “contact angle” refers to the angle that is exhibited between a wall surface of a container and the solid-vapor interface of where the coating meets a solid surface of the container. Coating particles on a surface of a collection container may have a contact angle (“α”) (as measured by goniometer) of at least 10°, 20°, or 30°. Coating particles on a surface of a collection container may have a contact angle (“α”) (as measured by goniometer) of less than 70°, 55° or 40°. FIG. 1c illustrates an example of a contact angle (α) relative to the surface 24. In the event the surface is curved, the contact angle would be measured from a line (lₜ) that is tangent to the surface at the edge of the coating. This is illustrated in FIG. 1d. It is possible that the surface 24 of the collection container is curved along one axis and flat or straight along another axis, such that there are two or more resulting contact angles that differ from each other. In those instances, an average contact angle may be employed, taking a plurality of measurements along the different axes (e.g., in equally divided increments about the particle “diameter”), and there will result in an average particle contact angle (“αₐᵥₑ”) (as measured by goniometer) of at least 10°, 20°, or 30°. Coating particles on a surface of a collection container may have an average particle contact angle (“αₐᵥₑ”) (as measured by goniometer) of less than 70°, 55° or 40°. For regions in which coating particles are present on a surface, it is possible that at least 40%, 50%, 60% or 70% by number of coating particles will have a contact angle or average particle contact angle (as measured by goniometer), of at least 10°, 20°, or 30°, and no more than about 70°, 55° or 40°. Such regions may have an area of 1 cm², 2 cm², 3 cm² or 4 cm² of an interior surface of the container. Such regions may have an area less than about 15 cm², 12 cm², 9 cm² or 6 cm². A container may include a single such region. A container may include a plurality of such regions. A container may include a plurality of such regions arranged in a predefined manner.

The coatings (whether in thin film form, coating particle form or a combination) in accordance with the present teachings may include a single layer or a plurality of layers. Each individual layer may be generally homogenous in composition. Each individual layer may have a varying composition. A plurality of adjoining layers may include the same composition in each layer relative to each other layer. A plurality of adjoining layers may each include a different respective composition. By way of one example, a coating may include a first layer that has as its major component (e.g., greater than 50%, 60%, 70%, 80% or 90% of the layer) a stabilizer. The coating may include a second layer having as its major component (e.g., greater than 50%, 60%, 70%, 80% or 90% of the layer) an anticoagulant. The coating may have an intermediate layer (which differs in composition from the first and the second layers) between the first layer and the second layer that is a mixture of the stabilizer and the anticoagulant.

A coating of the present teachings may be applied in a manner suitable for achieving the desired pattern. A coating may be applied onto a surface of a container and/or cover, onto a previously applied layer, or any combination thereof. A coating may be applied by dabbing, swabbing, wiping, and/or brushing. A coating may be applied by spraying. Among examples for possible application by spraying are applying by ultrasonic atomization.

A coating may be applied by printing. For example, a coating may be applied using a drop on demand print head (e.g., a piezoelectric and/or ultrasonic transducer driven drop-on-demand printhead). Under such circumstances the print head may include an elongated member having one or a plurality of nozzles in fluid communication with a fluid reservoir. The fluid reservoir can contain a reagent precursor in accordance with the present teachings. A pump or other delivery device can create a pressure differential, in cooperation with a transducer to cause the precursor to flow through the one or plurality of nozzles and deposit onto an inner surface of the container. The printhead may be translatably carried by an arm, shaft or other translation member of a motor (e.g., a servo motor). Translation longitudinally along an axis of the container, around an axis of the container, or both, is possible. The printhead may be heated for reducing the viscosity of the reagent precursor before ejection.

Upon coating, the reagent precursor is dried. It may be dried free of any step of freezing. It may be dried by application of heat. It may be dried by contacting the container with a heating element, thereby causing the container to heat by conduction and drive off moisture. It may be dried by passing a flow of heated gas (e.g., at a temperature greater than about 30° C., 40° C., or 50°) over the applied material. It may be dried under conditions in which the pressure is below atmospheric pressure (e.g., less than about 50 kPa, 40 kPa, 30 kPa or 20 kPa). Drying may employ a step of irradiating the reagent precursor with a source of electromagnetic radiation. For example, drying may employ a step of irradiation by microwave, by infrared or both. Drying may be free of any step of freeze drying. Any combination of the above drying techniques may be employed.

Conditions for a step of applying reagent precursor to a surface of a container, for a step of drying the precursor, or both, may be employed to impart porosity or other texture or topology on an individual external droplet surface. In this manner, it may be possible to increase surface area of particles by at least 25%, 35%, or 50% or more relative to a theoretical area if the surface was smooth.

The dried coating may include a reagent in a form that is capable of dissolving when the coating in the presence of, and upon contact with at least a portion of the liquid biological sample.

The dried coating may include a reagent in a form that is capable within the biological sample for causing stabilization of at least one target for omic analysis (e.g., one or more of cell-free nucleic acids, extracellular vesicles, circulating tumor cells, or any combination thereof).

The present teachings find particular application for the collection, storage and/or transport of blood samples, such as blood samples obtained by generally noninvasive techniques such as finger stick, microneedle, venipuncture or the like, in which the amount of blood drawn would be relatively low. Thus, the containers may be suitable sized to receive a blood sample of less than about 100 ml, 50 ml or 30 ml). Blood samples may be greater than 6 ml or 8 ml (e.g., about 10 ml). Blood samples may be relatively small, such as less than about 5 ml, 2 ml, or 1 ml (e.g., about 250 to about 500 microliters (μl).

The present teachings enable and contemplate of step transporting the biological sample in the container to a site at which analysis of a target (e.g., a circulating nucleic acid, an extracellular vesicle, a circulating tumor cell, or otherwise) contained within the sample is performed, by use of an instrument configured for omic analysis (e.g., a sequencing instrument, a PCR instrument, nuclear magnetic resonance instrument, liquid chromatography instrument, mass spectrometry instrument, any combination of such instruments, or some other omic analytical instrument is present). Because the analysis site is often remote from the collection site (e.g., by at least about 1 kilometer (km), 5 km, 20 km, 50 km, 100 km, 250 km), the present teachings enable stabilizing of the sample for analysis at a time when a non-stabilized sample would have degraded and destroyed sample usefulness. During the transporting the blood product sample may be refrigerated (e.g., to a temperature of less than 10° C.). During the transporting step, the blood product sample may be free from any refrigeration, and/or it is otherwise exposed to ambient conditions.

Further to the above, particularly in the case of blood samples, the present teachings enable and contemplate a step of retarding hemolysis of red blood cells present in the biological sample until after the transporting step has been completed.

The reagent of the present teachings (in the precursor and in a final coating) may include a formulation that results from mixing a stabilizer agent and an anticoagulant. The reagent may be the result of a mixture of a stabilizer agent and an anticoagulant in a relative proportion (by weight) of 0.1:5 to about 8:1. For example, the stabilizer agent may be combined with an anticoagulant in an amount by weight that is about 0.1:1 to about 1:0.1 relative to each other. There may be at least 1 part by weight of anticoagulant for every 1, 2, 3, 4, 5, 6, 7, 8, 9 or 10 parts by weight of stabilizer agent. There may be at least 1 part by weight of stabilizer agent for up every 1, 2, 3, 4, 5, 6, 7, 8, 9 or 10 parts by weight of anticoagulant. The anticoagulant may be present in an amount that exceeds the amount of stabilizer agent. The anticoagulant may be present in an amount that exceeds the amount of stabilizer agent by less than 300%. The stabilizer may be present in an amount that exceeds the amount of anticoagulant. The stabilizer may be present in an amount that exceeds the amount of anticoagulant by less than 300%.

The stabilizer agent may include diazolidinyl urea (DU), dimethylol urea, 2-bromo-2-nitropropane-1,3-diol, 5-hydroxymethoxymethyl-1-aza-3,7-dioxabicyclo (3.3.0)octane and 5-hydroxymethyl-1-aza-3,7-dioxabicyclo (3.3.0)octane and 5-hydroxypoly [methyleneoxy]methyl-1-aza-3,7-dioxabicyclo (3.3.0)octane, bicyclic oxazolidines (e.g. Nuosept 95), DMDM hydantoin, imidazolidinyl urea (IDU), 4,4′-Methylene-bis(1,2,4-thiadiazinane)-1,1,1′,1′-tetraoxide, sodium hydroxymethylglycinate, hexamethylenetetramine chloroallyl chloride (Quaternium-15), biocides (such as Bioban, Preventol and Grotan), a water-soluble zinc salt or any combination thereof. The stabilizer may include a formaldehyde donor compound. For example, the stabilizer agent may include DU, IDU or a combination of both.

The anticoagulant may include one or more compounds that bind with calcium ions and help prevent clotting. The anticoagulant may include ethylenediaminetetraacetic acid (EDTA) (e.g., provided as either or both of K₃EDTA or K₂EDTA, or another salt form). The anticoagulant may include a citrate (e.g., trisodium citrate or an acid-citrate-dextrose, such as citric acid, trisodium citrate, and dextrose). The anticoagulant may include an oxalate (e.g., potassium oxalate). The anticoagulant may include heparin. The anticoagulant may include ethylene glycol-bis-{β-aminoethyl ether}-N,N,N′,N′-tetraacetic acid (EGTA). The anticoagulant may include diethylenetriamine penta-acetic acid (DTPA). Any combination of two or more anticoagulants enumerated above may be employed.

Starting materials for making the reagent (or reagent precursor) of the teachings, and the resulting reagent (or coating thereof) may optionally include a compound that includes at least one functional group capable of reacting with an electron deficient functional group of an aldehyde. The optional compound may possess an amine functionality. The optional compound may be an amine compound that reacts with formaldehyde to form methylol and/or imine Schiff base or a cis-diol compound that reacts with formaldehyde to form a cyclic acetal). The optional compound may be selected from amino acids, alkyl amines, polyamines, primary amines, secondary amines, ammonium salts, nucleobases or any combination thereof. The optional compound may be selected from glycine, lysine, ethylene diamine, arginine, urea, adinine, guanine, cytosine, thymine, spermidine, or any combination thereof.

Starting materials for making the reagent (or reagent precursor) of the teachings, and the resulting reagent (or coating thereof) may include a polysaccharide, an oligosaccharide, a functionalized derivative of either, or any combination thereof. Preferably, the reagent may include a polysaccharide. They may include a cyclic polysaccharide, a cyclic oligosaccharide, a functionalized derivative of either, or any combination thereof. They may include a cyclic polycyclodextrin, a cyclic oligocyclodextrin, a functionalized derivative of either, or any combination thereof.

Starting materials for making the reagent (or reagent precursor) of the teachings, and the resulting reagent (or coating thereof) may include one or any combination of a protease inhibitor, a nuclease inhibitor, a phosphatase inhibitor, or a metabolic inhibitor.

A nuclease inhibitor may be selected from the group consisting of: diethyl pyrocarbonate, ethanol, aurintricarboxylic acid (ATA), formamide, vanadyl-ribonucleoside complexes, macaloid, ethylenediamine tetraacetic acid (EDTA) (e.g., provided as either or both of K₃EDTA or K₂EDTA, or another salt form), proteinase K, heparin, hydroxylamine-oxygen-cupric ion, bentonite, ammonium sulfate, dithiothreitol (OTT), betamercaptoethanol, cysteine, dithioerythritol, tris(2-carboxyethyl) phosphene hydrochloride, or a divalent cation such as Mg+2, Mn+2, Zn+2, Fe+2, Ca+2, Cu+2 and any combination thereof.

A protease inhibitor may be selected from the group consisting of: antipain, aprotinin, chymostatin, elastatinal, phenylmethylsulfonyl fluoride (PMSF), APMSF, TLCK, TPCK, leupeptin, soybean trypsin inhibitor, indoleacetic acid (IAA), E-64, pepstatin, VdLPFFVdL, EDTA, 1,10-phenanthroline, phosphoramodon, amastatin, bestatin, diprotin A, diprotin B, alpha-2-macroglobulin, lima bean trypsin inhibitor, pancreatic protease inhibitor, egg white ovostatin, egg white cystatin, Doxycycline, Sulfasalazine, Curcumin, Homocysteine, 6-Aminocaproic acid, Doxycycline, Minacycline HCl, Nicotinamide, Chitosan, Lysine, Glyceraldehyde, Phytic Acid, b-Sitoserol, C-AMP, Poly Lysine Low MW, Biochanin A, Sulfasalazine, Demeclocycline, Chlortetracycline, Oxytetracycline, Cyclohexamide, Rifampicin, Soy Milk, Suramin, N-Butyric Acid, Penicillamine, N-Acetyl Cysteine, Benzamidine, AEBSF, and any combination thereof.

A phosphatase inhibitor may be selected from the group consisting of: calyculin A, nodularin, NIPP-1, microcystin LR, tautomycin, sodium molybdate dihydrate, okadaic acid, cantharidin, microcystin LR, hexahydro-3a,7a-dimethyl-4,7-epoxyisobenzofuran-1,3-dione, fostriecin, tautomycin, polyethylene glycol, cantharidin, endothall, nodularin, cyclosporin A, FK 506/immunophilin complexes, cypermethrin, deltamethrin, fenvalerate, bpV(phen), dephostatin, mpV(pic) DMHV, sodium orthovanadate, and any combination thereof.

Other ingredients are possible for use in the reagent of the present teachings including one or more amines, amino acids, amides, alkyl amines, polyamines, primary amines, secondary amines, ammonium salts, or any combination thereof. One more apoptosis inhibitors may be employed to make the reagent (and its precursor), as well as one or more optional caspase inhibitors. The reagent may include one or more transcription inhibitors (e.g., actinomycin D, a-amanitin, triptolide, 5,6-dichloro-1-13-D-ribofuranosylbenzimidazole(ORB), flavopiridol, or any combination thereof). The reagent may include a colorant or dye.

Starting materials for making the reagent (or reagent precursor) of the teachings, and the resulting reagent (or coating thereof) may include a guanidine compound, a salt and/or a derivative of such compound. The present teachings may include, as part of the starting materials for a reagent precursor formulation, a polyamine compound (e.g., a naturally occurring polyamine, a synthetic polyamine, or a combination thereof), a salt and/or a derivative of such compound. The present teachings may include, as a starting material for a reagent precursor formulation a metal salt (e.g., a halide of an alkali metal, an alkali earth metal or any combination thereof). The present teachings may include, as a starting material for a reagent precursor formulation an antioxidant (e.g., beta-mercaptoethanol). The present teachings may include, as a starting material for part of a reagent precursor formulation a protein denaturant (e.g., guanidium thiocyanate). A surfactant (e.g., a nonionic surfactant, such as a polyether including a polyoxyethylene chain) may also be employed. The reagent of the present teachings may include sodium azide. The starting materials for the reagent of the present teachings may include an anticoagulant in combination with one of the ingredients of this paragraph (e.g., a combination of sodium azide and EDTA.

It may be preferred that the stabilizing components are substantially free of any reactivity during the spraying and drying process. This lack of reactivity may improve one or more of the shelf life of the containers or the ability to sufficiently stabilize a biological sample. However, it is possible that there may be some reactivity between the stabilizing components during the spraying and drying process.

Examples of patent literature in the area of stabilization includes United States (“US”) Patent Application Publication No. 20100184069 A1 (“Preservation of Fetal Nucleic Acids in Maternal Plasma”); US Patent Application Publication No. 20160257995 A1 (“Stabilization of Nucleic Acids in Urine”); U.S. Pat. No. 10,144,955 (“Methods for Preservation of Cell-free Nucleic Acids”); and U.S. Patent Application No. 62/574,515 and International Application Publication No. WO 2019/079743A1 (“Compositions for Hemolysis and Coagulation Regulation and Stabilization of Extracellular Vesicles”), all of which are incorporated by reference for all purposes. The formulations described in each of these publications can find suitable use in the present teachings.

During its useful shelf-life, the total amount of reagent (after drying and before receiving a sample) within a container may be less than about 2, 1, 0.6, 0.4, 0.2, or 0.1 grams (g). The total amount of reagent (after drying and before receiving a sample) within a container may be greater than about 0.0001, 0.001, 0.01, or 0.05 g. By way of example, without limiting to any of the other amounts disclosed, the total amount of reagent (after drying and before receiving a sample) within a container may range from about 0.1 milligram (mg) to 100 mg, or even about 1 mg to about 10 mg.

The amount of anticoagulant (by weight (as all amounts herein are expressed, unless noted otherwise)) relative to any other ingredient in the coating can be at least about 5%, 15% or 25% of total weight. The amount of anticoagulant (by weight (as all amounts herein are expressed, unless noted otherwise)) relative to any other ingredient in the coating can be less than about 80%, 70% or 60% of total weight.

The reagent while in solution, before it is applied as a coating and liquid is removed, may have a pH of at least about 3.5, 4.5 or 5.5. The reagent before it is applied as a coating may have a pH of at least about 3.5, 4.5 or 5.5. It may have a pH that is less than 9.5, 8.5, or 7.5.

The reagent while in solution, before it is applied as a coating and liquid is removed, may have an osmolarity of at least about 150, 250, 300, or 350 milliosmoles per kilogram. It may have an osmolarity of less than about 650, 600, 550, 500, 450 or 400 milliosmoles per kilogram.

An interior surface of a container of the present teachings may be coated or otherwise treated to modify its surface characteristics. For example, an interior surface may be treated to render it more hydrophobic and/or more hydrophilic, over all or a portion of the surface. The tube may have an interior surface flame sprayed, subjected to corona discharge, plasma treated, coated or otherwise treated. At least a portion of an interior wall surface may be coated with a substance so that nucleic acids or other targets of interest will resist adhering to the tube walls. At least a portion of an interior wall surface may be coated with a substance so that nucleic acids or other targets of interest will bind to the surface.

The teachings herein make possible numerous advantages as compared with existing technologies. An example of an advantage of the teachings includes that the concentration of the ingredients in the reagent, when coated and stored in a collection container of the teachings exhibit prolonged stability during storage under ambient conditions (e.g., at about room temperature and/or over a temperature range of about 6° C. to about 37° C., atmospheric pressure and a relative humidity of about 40% to about 60%) for at least about 90 days, 180 days, one year, one and a half years, or two years. The teachings, accordingly, contemplate a step of storage under ambient conditions (e.g., at about room temperature and/or over a temperature range of about 6° C. to about 37° C., atmospheric pressure and a relative humidity of about 40% to about 60%) for at least about 90 days, 180 days, one year, one and a half years, or two years.

An example of an advantage of the teachings includes that, when used to collect a blood sample, that amount of resulting hemolysis of red blood cells is retarded by at least about 15%, 25%, 35% or more after a period of at least 3 days from collection of the sample into the container, as compared with a liquid state reagent having the same ingredients, but dissolved in a solvent such as water. Thus, the teachings herein envision a step of retarding hemolysis of red blood cells by at least about 15%, 25%, 35% or more after a period of at least 3 days from collection of the sample into the container as compared with a liquid state reagent having the same ingredients, but dissolved in a solvent such as water.

An example of an advantage of the teachings includes that, when a sample is introduced into a container having a reagent coating as taught herein, the sample is exposed to the reagent at a slower rate than if the reagent initially is in a liquid state. The resulting slower exposure rate can help to achieve a more uniform dispersion of the reagent within the sample. The resulting slower exposure rate can help to reduce the potential for shock to a portion of the sample that could occur if the reagent initially is in a liquid state. The teachings, accordingly, contemplate a step of exposing a sample to a stabilizer agent maintained in a solid state at a slower rate than if the reagent initially is in a liquid state.

An example of an advantage of the teachings includes that lower overall amounts of reagent can be employed for stabilizing a sample as compared with amounts of reagent initially in liquid state to achieve comparable stabilization results. For example, the total amounts of stabilizer agent that is required in the coating is less than about 80%, 70% or 60% of the amount of stabilizer agent that would be needed to achieve substantially the same stabilization as if in liquid form at the time when initially contacted with the liquid of the biological sample.

An example of an advantage of the teachings is that a container is possible that meets International Safe Transit Association (ISTA) 1A Testing requirements. Further, upon being subjected to those testing requirements, the coatings herein withstand delamination from the container.

An example of an advantage of the teachings is that a container having been coated as taught is able to withstand pressure differential testing was performed in accordance with FDA requirement 49 CFR § 173.196(a)(6). Thus, the container in sealed condition is capable of withstanding, without leakage, an internal pressure producing a pressure differential of not less than 95 kPa for at least 30 minutes. Additionally, coatings subjected to those conditions remain intact within the container and withstand delamination from the container.

An example of an advantage of the teachings is that methods may be free of separately adding and/or handling of any materially significant concentration (e.g., less than about 1% by weight, more preferably less than about 0.5% by weight, more preferably less than about 0.1% by weight of formaldehyde and/or paraformaldehyde prior to any contact with a biological sample having a liquid phase. In this regard, prior to any contact with a biological sample having a liquid phase, coatings of the teachings may be free of formaldehyde and/or paraformaldehyde in an amount greater than about 3% by weight, 2% by weight, 1% by weight, 0.5% by weight, or 0.1% by weight of the coating composition. For purposes of the present teachings, amounts of formaldehyde is measured by high performance liquid chromatography (“HPLC”)-with ultraviolet (“UV′) detection. An example of a suitable protocol includes using a Shiseido, Capcell Pak C18 UG120 column, 4.6×250 mm, 5 μm, at ambient column temperature, injection volume of 10 flow rate of 1 ml/min, a mobile phase of Water-Acetonitrile (55:45), detection at 360 nm and run time of 20 min. Formaldehyde standard solutions are made for defining a known amount of formaldehyde. Derivatization conditions to yield a detectable signal are employed using 20 μL of 5N phosphoric acid, and 200 μL of 2,4-dinitrophenylhydrazine solution added into a vial and stirred for at least 30 min and then 1 mL of acetonitrile is added. It should also be appreciated that from the time of contacting the coating with a biological sample and until the sample is analyzed, the contents of a container of the present teachings is expected to have no detectable formaldehyde.

The containers and methods of the teachings herein may be suitably employed in a workflow for an omics analysis, such as analysis for genomics, transcriptomics, proteomics, or metabolomics, lipidomics, or any combination thereof. The analysis may be directed toward an isolated nucleic acid, cell, exosome, protein, metabolite or other target. The analysis may be directed toward cell separating techniques, single cell and single molecule measurement, imaging or other characterization techniques. The analysis may involve analysis of an immunological response, oncological response, metabolic response, or otherwise.

The present teachings also find applicability with one or more sample preparation techniques. The sample preparation techniques may take place prior to any instrument performs any identification, quantification, and/or characterization of a constituent of the sample in an analysis. For example, the teachings find applicability with one or more steps of enriching a target, preparing a library (e.g., preparing an array of samples (such as an array of about 100 (e.g., 96) to about 400 samples (e.g., 384) on common substrate that carries a plurality of wells into which each sample respectively is introduced), or both.

The present teachings are illustrated by reference to the following nonlimiting examples.

### Example 1

Four formulations are employed as follows, two in liquid form and two in spray coated form in blood collection tubes: 1) EDTA in liquid form as a control; 2) 200 microliters of fresh liquid reagent having a formulation of a combination of or reaction product of imidazolidinyl urea, EDTA and glycine (and having a sample fill volume of 10 mL); 3) 40 microliters of a reagent having the same initial components as the 200 microliter liquid reagent (imidazolidinyl urea, EDTA and glycine) are spray coated ultrasonically and dried; and 4) 80 microliters of a reagent having the same initial components as the 200 microliters of liquid reagent product are spray coated and dried.

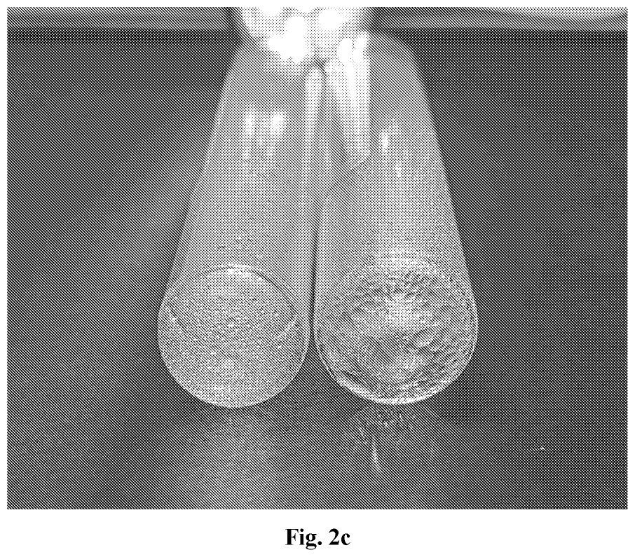

Whole blood from three different donors is introduced immediately upon draw into the tubes and is either processed to plasma immediately (Day-0) or allowed to incubate at room temperature for 7 days. Plasma is isolated and cell free DNA (“cfDNA”) is purified using the QIAamp Circulating Nucleic Acid Isolation Kit. Purified cfDNA is then assayed using both the fluorometric Qubit assay and droplet digital PCR with primer/probe sets targeting Beta-Actin. The EDTA control demonstrates robust increases in cfDNA indicating white blood cell (“WBC”) lysis and poor sample stabilization, while the liquid reagent having a formulation of the Streck Cell Free DNA BCT® product behaved as expected resulting in maintenance of draw-time cfDNA levels out to at least 7 days post blood draw. The spray dried samples demonstrate strong maintenance of cfDNA levels. Results are seen in FIG. 3a and FIG. 3b. For each entry, Day 0 samples are on the left, and Day 7 samples are on the right. The results show a surprising ability to reduce the amount of reagent in a tube through coating as compared with current conventional amounts of liquid reagent without sacrificing performance.

### Example 2

Various tube materials, stabilizer amounts and coating lengths are selected and uniformity of the coating, droplet size of the coating and coverage quality of the coating are observed. The results are shown in Table 1.

TABLE 1

| Reagent | Coating | Tube | | Droplet | |
|---|---|---|---|---|---|
| amount | length | material | Uniformity | Size | Coverage |
| 110 mg | 9 cm | glass | very uniform | small | complete |
| 110 mg | 9 cm | plastic | uniform | very small | complete |
| 75 mg | 9 cm | glass | uniform | small | complete |
| 75 mg | 9 cm | plastic | uniform | small | complete |
| 50 mg | 9 cm | glass | non-uniform | mixture of | non- |
| | | | | large and | complete |
| | | | | small | |
| 50 mg | 9 cm | plastic | less uniform | small | non- |
| | | | | | complete |
| 110 mg | 7 cm | glass | less uniform | mixture of | complete |
| | | | | large and | |
| | | | | small | |
| 110 mg | 7 cm | plastic | less uniform | small | complete |
| 110 mg | 5 cm | glass | non-uniform | large | non- |
| | | | | | complete |
| 110 mg | 5 cm | plastic | non-uniform | mixture of | non- |
| | | | | large and | complete |
| | | | | small | |

As a result of the forgoing example, the following results are observed: The use of glass as a substrate results in more well-defined visible droplets inside tube. In the case of glass tubes, the overall coverage of coating inside tube is observed to be slightly better than plastic tubes. The use of lower amount of stabilizer decreased the quality of coating. Streaks onto tube walls are observed by decreasing from 110 mg to 55 mg. This may be due to an excess amount of water since lowering the stabilizer amount was done by diluting the reagent. Lastly, decreasing the coating length results in dripped coating.

### Example 3—Spray Coated Blood Microtubes

Two different microtubes types, Microtube 1 (MT1) (liquid pellet) and Microtube 2 (MT2) (spray-coated) receive the stabilizing components described at Example 1. MT1 is a microtube capable of holding 0.25 mL fill volume and receives 25 uL of stabilizing reagent was. Thus, 10× dilution occurs when the sample is added. MT2 is a microtube capable of holding 0.5 mL fill volume and 40 uL of stabilizing reagent is spray-coated into the tube resulting in 12.5× dilution when the sample is added. MT2 receives a non-uniform spray-coating application pattern, while the MT1 tubes receive a ˜25 uL liquid pellet spray deposition. Spray deposition techniques include the droplet stream being produced from a molten bath or by continuous feeding of cold metal into a zone of rapid heat injection.

Blood from a single self-declared “healthy” donor is collected via venipuncture into 5×10 mL K₂EDTA collection tubes. The five tubes are combined and blood immediately aliquoted into both the MT2 tubes (n=24 replicates, 0.5 mL per tube) or the MT1 tubes (n=24 replicates, 0.25 mL per tube). Controls for this experiment consist of the same K2 K₂EDTA blood aliquoted into 1.5 mL epi-tubes (n=12, 1 mL per tube) or 1.5 mL epi-tubes containing 20 uL of the stabilizing reagent of Example 1 (“CFDNA”) (n=12, 1 mL per tube). All tubes are mixed 20-25× in order to dissolve the spray-coating or pellet application completely. Tubes are then processed immediately for “draw time” testing OR allowed to incubate at ambient laboratory temperature for seven days (“Day-7” functional testing).

MT1 and MT2 tubes at both draw time and Day-7 are spun at 1,800 g for 15 min and are observed for hemolysis. Overall levels of hemolysis are low at draw time for all samples. Mild elevations are noted for the MT1 tubes, however, this was likely the result of greater mixing for these samples. Day-7 samples all demonstrate increases in hemolysis relative to draw time. Both MT1 and MT2 tubes display hemolysis similar to control tubes containing the stabilizing reagent of Example 1 (“CFDNA”). The Day-7 K₂EDTA samples display the greatest amount of hemolysis as expected for an unstabilized blood sample.

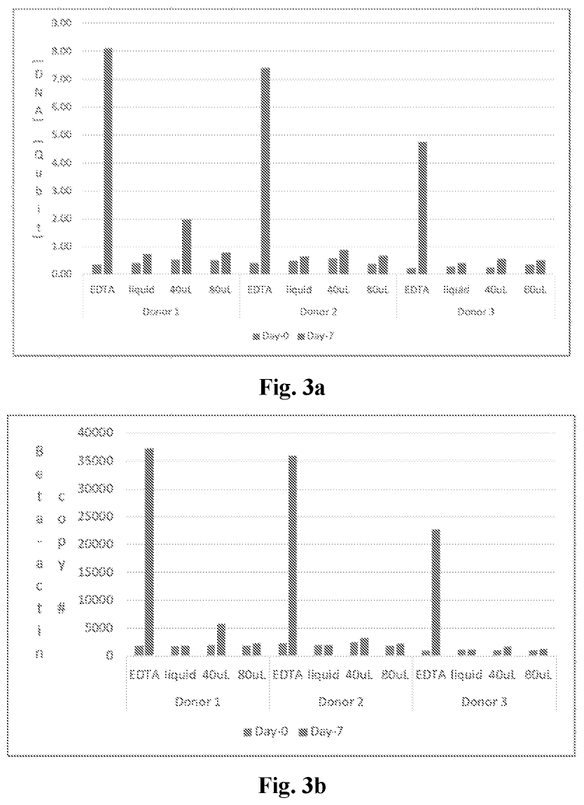

Supernatant is removed and then spun at 2,800 g for 15 min. The cleared supernatant is used to determine quantitative levels of hemolysis using the Thermo-Fisher NanoDrop1000 spectrophotometer with absorbance at 414 nm recorded (hemoglobin absorbs at this wavelength). Quantitative results were similar to that observed by visual inspection. Levels of hemolysis mirror that observed visually and results are shown at FIG. 4. Both of the MT1 and MT2 tubes display Day-7 hemolysis levels comparable to the control reagent of Example 1 (dotted line).

Determination of plasma cell-free DNA levels—The intended use of the spray-coated microtubes is maintenance of draw time plasma cell-free DNA levels via stabilization of DNA-containing cells, such as white blood cells. Cleared plasma samples obtained above are utilized in plasma nucleic acid isolations according to commercially available kit instructions (QIAamp Circulating Nucleic Acid Isolation Kit, Qiagen). Resultant cfDNA is then utilized in both quantitative and qualitative assays.

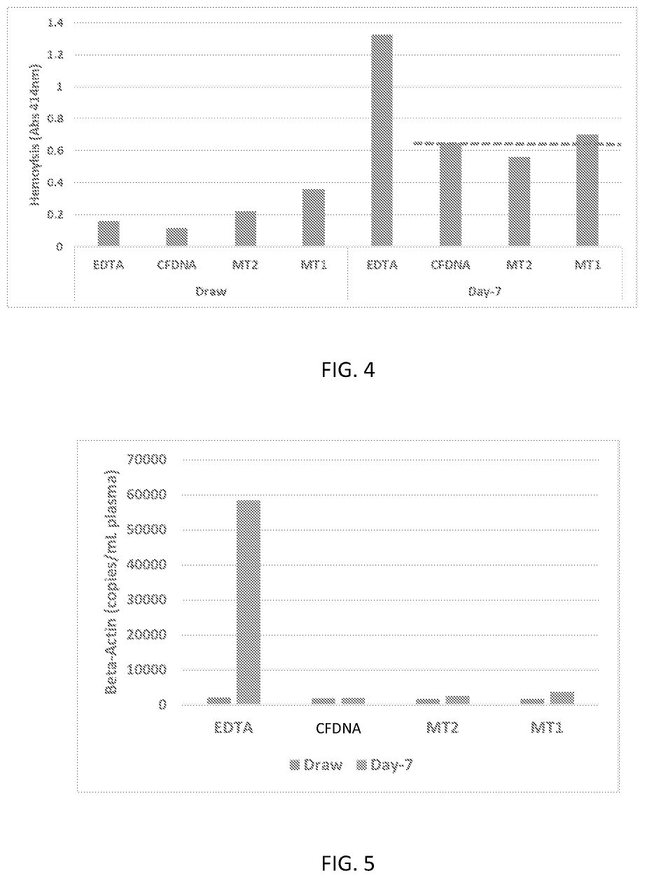

Quantification of cfDNA abundance utilizes a primer/probe set recognizing the housekeeping gene β-actin in combination with the Bio-Rad Droplet Digital PCR (ddPCR) workflow. Overall levels at draw time are similar between MT1 and MT2. No difference is observed between K₂EDTA, Example 1 (CFDNA) reagent, MT1, or MT2 as shown at FIG. 5. The K₂EDTA samples demonstrate a dramatic increase in β-actin abundance after 7-days of blood storage while samples stored in the CFDNA reagent, MT1, or MT2 microtubes displayed maintenance of draw time β-actin abundance, and hence cfDNA levels.

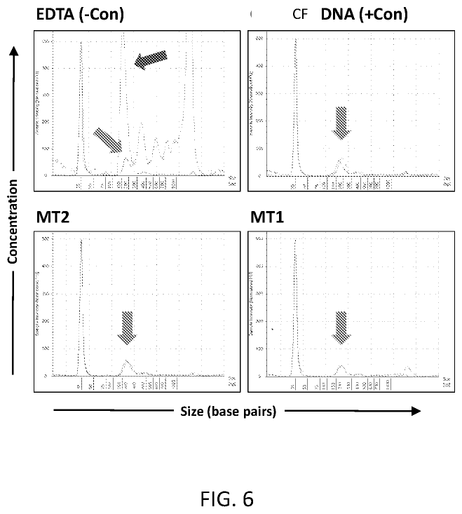

Qualitative analysis of cfDNA levels utilizes the Agilent TapeStation instrument with the associated cfDNA Screentape Assay. This specific assay provides information regarding relative cfDNA concentration and cfDNA size. Similar to results with ddPCR, cfDNA levels are unstable in K₂EDTA with dramatic increases observed on Day-7 relative to draw time as shown at FIG. 6. For all other tubes, plasma cfDNA concentration is maintained out to 7-days of ambient storage Samples were near completely superimposable on each other suggesting maintenance of both cfDNA concentration and overall size. In all cases, including K₂EDTA, plasma cfDNA maintain the appropriate draw time size of roughly ˜170 base pairs.

Altogether, these analytical results demonstrate that the spray-coated microtubes perform similarly to the stabilizing reagent of Example 1 “positive” control and maintain draw time concentrations of cell-free DNA out to 7-days of ambient condition storage. This example demonstrates that for maintaining draw time cell-free DNA profiles in stored blood, samples can be both, 1) miniaturized to 20-40-fold lower volumes and 2) can utilize spray-coating technology to supplant for the current liquid stabilizing reagent. In all cases tested (both spray coated and with deposition) levels of hemolysis were the same for the microtubes and the control Example 1 reagent. Similarly, the functionalized microtubes maintained the draw time cfDNA concentration out to 7-days of ambient whole blood storage.

General remarks applicable to the each of the embodiments described herein are present in the remainder of the discussion that precedes the claims.

The present teachings meet one or more of the above needs by the improved devices and processes described herein. As can be seen, a number of advantages and benefits are possible in accordance with the teachings. The teachings provide a unique sample collection approach that addresses some of the pre-analytical needs faced by practitioners. The teachings also make possible the rapid proliferation of techniques for omic analysis, by providing a unique method of analyzing a biological sample, that includes performing an omic analysis upon a biological sample that has been stabilized by contact with a substantially dried coating of a reagent resulting from a mixture of an anticoagulant with a stabilizing agent, as described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

All percentages herein are by weight, unless otherwise stated.

It should be recognized that in the present teachings, unless otherwise stated, reference in a teaching to the generic form of “nucleic acid” contemplates not only the genus of nucleic acids, but also individual species of nucleic acid (such as fetal DNA, fetal RNA, DNA, RNA, mRNA, tumor DNA, tumor RNA, or otherwise even if such species is not referenced in the passage at hand.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “pans by weight” herein also contemplates the same ranges expressed in terms of percent by weight. Thus, an expression in the Detailed Description of the Teachings of a range in terms “‘χ’ of at parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus. “about 20 to 30” is intended to cover “about 20 to about 30”, inclusive of at least the specified endpoints. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination (for present purposes a material effect upon basic and novel characteristics is one that is exemplified by an adverse departure of at least 20% of a property value stated to describe the characteristic). The use of the terms “comprising” or “including,” to describe combinations of elements, ingredients, components or steps herein also contemplates embodiments that consist essentially of or even consist of the elements, ingredients, components or steps.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the hill scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1. A method of making a biological sample collection container, comprising:
a) providing a container including a base; at least one side wall having a length and that is attached to the base, and including structure for defining an opening configured for receiving a cover and for receiving a biological sample, the at least one side wall defining a chamber having a volume within which a biological sample is received;
b) depositing a reagent comprising an anticoagulant and one or more stabilizing components in a liquid state at least partially along at least one side wall of the container;
c) drying the reagent to form a dried coating of the reagent along at least a portion of the at least one side wall, wherein:
i) the coating includes, in a dried state, a formulation that results from mixing the one or more stabilizer components and the anticoagulant;
ii) the coating is formulated, and applied to be in a form, that:
1) exhibits a substantially constant concentration of the formulation that results from mixing the stabilizer agent and the anticoagulant or individual, and/or ingredients and/or reaction products thereof, after being subjected to ambient storage conditions over a period of at least 90 days,
2) dissolves in the presence of a liquid phase of the biological sample;
3) disperses within a liquid phase of biological sample substantially contemporaneously with a collection of the biological sample for causing stabilization of any present white blood cells, cell-free nucleic acids,
extracellular vesicles, circulating tumor cells, proteins, metabolomes, or any combination thereof, and preserving them in sufficient quantity and quality for omic analysis.

2. The method of claim 1, wherein the dried coating has a predefined pattern and topology.

3. The method of claim 1 or 2, wherein the reagent includes, as a starting material ingredient, a stabilizer agent selected from one or any combination of diazolidinyl urea (DU), dimethylol urea, 2-bromo-2-nitropropane-1,3-diol, 5-hydroxymethoxymethyl-1-aza-3,7-dioxabicyclo (3.3.0)octane and 5-hydroxymethyl-1-aza-3,7-dioxabicyclo (3.3.0)octane and 5-hydroxypoly [methyleneoxy]methyl-1-aza-3,7-dioxabicyclo (3.3.0)octane, bicyclic oxazolidines (e.g. Nuosept 95), DMDM hydantoin, imidazolidinyl urea (IDU), sodium hydroxymethylglycinate, hexamethylenetetramine chloroallyl chloride (Quaternium-15), biocides (such as Bioban, Preventol and Grotan), or a water-soluble zinc salt.

4. The method of any of claims 1 through 3, wherein the reagent includes as a starting material an ingredient with an amine functionality.

5. The method of any of claims 1 through 4, wherein the reagent includes cyclodextrin or a functionalized derivative thereof as a starting material ingredient.

6. The method of any of claims 1 through 5, wherein the reagent includes as a starting material ingredient one or any combination of anticoagulants selected from ethylenediaminetetraacetic acid (EDTA), a sodium citrate or an acid-citrate-dextrose, an oxalate or heparin.

7. The method of any of claims 1 through 6, wherein the reagent includes as starting material ingredients a stabilizer agent and an anticoagulant in a relative proportion (by weight) of 0.1:5 to about 8:1.

8. The method of any of claims 1 through 6, wherein the coating is in the form of a predetermined pattern of microparticles, a continuous thin film over a region of at least 2 cm² or a combination thereof.

9. The method of any of claims 1 through 8, wherein the step of coating includes applying a plurality of layers that differ in composition relative to each other.

10. The method of claim 9, wherein a layer of the anticoagulant is applied over a layer of the one or more stabilizing components.

11. A container comprising:
a base;
at least one side wall having a length and that is attached to the base, and including structure for defining an opening configured for receiving a cover and for receiving a biological sample, the at least one side wall defining a chamber having a volume within which a biological sample is received;
a reagent comprising an anticoagulant and one or more stabilizing components in a liquid state located at least partially along at least one side wall of the container;
a substantially constant concentration of the reagent that results from mixing the one or more stabilizing components and the anticoagulant or individual, and/or ingredients and/or reaction products thereof, after being subjected to ambient storage conditions over a period of at least 90 days.

12. The container of claim 11, wherein the reagent dissolves in the presence of a liquid phase of the biological sample.

13. The container of claim 11 or claim 12, wherein the reagent disperses within the biological sample substantially contemporaneously with a collection of the biological sample for causing stabilization of any present white blood cells, cell-free nucleic acids, extracellular vesicles, circulating tumor cells, proteins, metabolomes, or any combination thereof, and preserving them in sufficient quantity and quality for omic analysis.

14. The container of any of claims 11 through 13, wherein the reagent forms a dried coating including a predetermined array of discrete microparticles located along the at least one side wall, a thin film over at least one region of at least about 2 cm² of the side wall, or both.

15. The container of any of claims 11 through 14, wherein the fill volume of the container is 1 mL or less, or even 0.5 mL or less.

16. The container of any of claims 11 through 14, wherein the reagent is located into the container as a dispersion.

17. The container of any of claims 11 through 15, wherein the amount of reagent located into the container is 80 microliters or less, 60 microliters or less, 40 microliters or less, or even 20 microliters or less.

18. The container of any of claims 11 through 16, wherein the amount of biological sample located into the container is 10 mL or less, 8 mL or less, 6 mL or less, or even 4 mL or less.

19. A method of collecting a liquid biological sample in a collection container, comprising introducing a biological sample having a liquid phase into a spray coated collection container having a fill volume of 1 mL or less, or even 0.5 mL or less.

20. The method of any of claims 1 through 10, wherein the method includes transporting the biological sample in the container to a site at which an omic analysis is performed.

21. The method of claims 1 through 10, wherein the method includes performing an omic analysis is performed.

22. The method of claim 21, wherein the performing an omic analysis includes one or any combination of steps including isolating a target, enriching a target, preparing a library, performing PCR, sequencing, or any combination thereof.

23. The method of claim 21 or 22, wherein the step of performing an omic analysis is done at least 36 hours after introducing the biological sample into the container.

24. The method of any of claims 20 through 23, wherein the step of performing an omic analysis is done no greater than 7 days after introducing the biological sample into the container.

25. Use of the method of any of claims 20 through 24, wherein the biological sample is from a patient undergoing diagnosis for a disease condition, a patient undergoing treatment for a disease condition, or both.
